(19) United States
(12) Patent Application Publication
(10) Pub. No.: US 2014/0086456 A1
(43) Pub. Date: Mar. 27, 2014

(54) Using Facial Recognition to Match Reproductive Tissue Donors and Recipients

(71) Applicant: Arthur Joseph Frawley, Montgomery, AL (US)

(72) Inventor: Arthur Joseph Frawley, Montgomery, AL (US)

(21) Appl. No.: 13/624,961

(22) Filed: Sep. 23, 2012

(51) Int. Cl. G06K 9/62

(52) U.S. Cl. 382/118

(57) ABSTRACT

The Precision Donor System uses facial recognition software to allow reproductive tissue recipients (patients) to more closely match with reproductive tissue donors. Confidence in the selection of a donor leads to a greater acceptance of the child produced using the donor tissue. Using the program allows anonymous donors to remain anonymous. Patients can remain anonymous while feeling confident that the choice of donor they are making is the best match. The closer patients can match to their donors, the easier they can accept the necessity of using donor tissue, and the children produced.

A Facial Recognition Program (FRP) converts images of faces to Eigen Masks (mathematical models of faces), allowing a comparison of a target (patient) model or Eigen Mask with the database of stored (donors) models or Eigen Masks.

The database of stored models or Eigen Masks generated by the FRP includes information about reproductive tissue donors. The target or patient model is compared against the stored or donor models and the top tem matches are returned. The conversion of facial images to Eigen Masks enables a one to many, comparison while maintaining the privacy of both the patients and the donors.

The database will be generated from tissue banks entering their donor information and photos through a secure online portal. These photos will be converted to Eigen Masks by the FRP. The database of available tissue donors is augmented by using a series of questions such as height, eye color, hair color, etc . . . and attached to each record is the donor's Eigen Mask. The patients will be registered at participating physicians' offices through a secure online portal. The default search returns the top ten matches by facial recognition only. The patient can then refine their choices by using the search criteria of height, eye color, hair color, etc . . . The patient's access credentials will be good for 30 days from the date of initial logon to the database through the secure online portal. The patients can reconfigure their searches, save results, and link to the donor's profile page on the tissue bank's website for more information. The participating physicians' office will be billed monthly based on the number of patients' photos uploaded.

A tissue bank enters the data on a donor, catalog number or donor number, availability, public profile URL, hair color, eye color, hair texture, skin tone, height, ancestry, blood type, religion, education level, specimen type, bank, and photo (the photo will be converted to an Eigen Mask by the FRP). These profiles will be stored in a secure database. The tissue bank repeats the process for each of its donors. This will populate the database.

A patient seeking reproductive tissue is registered with the system at a participating physicians' office. This insures that only legitimate patients have access to the system. It also prevents the database from obtaining any confidential medical information, as the patients will only be identified to the program by a randomly generated username and password. They are given system generated username and password which will be valid for 30 days after their initial login. A photo is uploaded to the system through the FRP interface on the secure online portal by the participating physicians' office. The patient pays the fee to the participating physicians' office. The participating physicians' office will be billed monthly based on the number of patients they register into the system. The patients use the credentials generated by the system to access the system through a secure online portal. Patients may reconfigure search criteria by using the variables of height, eye color, hair color, etc . . . Patients can save searches, mark individual donors as favorites, and link to the public profile of the donors at the tissue bank's website by clicking the URL link. The default search returns the top ten matches by facial recognition matching only.

### BACKGROUND OF INVENTION

Utilizing facial recognition allows reproductive tissue recipients (patients) to more closely match with reproductive tissue donors. Fewer than 15% of all reproductive tissue donors are “known” donors. Known donors are those donors allowing their photos and personal information to be shared with potential recipients. Unfortunately this means a relatively small pool of donors are available for those patients seeking an extra level of certainty. Confidence in the selection of a donor leads to a greater acceptance of the child produced using the donor tissue. Using the program allows anonymous donors to remain anonymous. Patients can remain anonymous while feeling confident that the choice of donor they are making is the best match. The closer patients can match to their donors, the easier they can accept the necessity of using donor tissue, and the children produced.

### BRIEF SUMMARY OF INVENTION

Using facial recognition software to match reproductive tissue donors and recipients allows for a precise match without sacrificing the privacy of either the donor or the recipient. Participating Sperm Banks load their Sperm Donor images through our web portal. The images of the donors are run through a series of programs called Biometric Facial Recognition. These programs create mathematically precise models of the donors' facial features. They are stored by the system not as an image but as a series of mathematical expressions. Patients enter their images through the portal at Participating Physician's Office and the same process is applied. This insures that there is no identifying information sent to Precision Donor, and the Patient's Privacy is assured. The Patient's mathematical model is then compared to every model in the database and the 10 best matches are returned. The Patient may then include or exclude resultant donors based on adjustments made to the search criterion over the next 30 days from their initial login. Once the list is narrowed down to a few donors the Patient may click on the link with any donor and be re-directed to the Participating Bank's Donor Page. They may then contact the Bank directly to obtain more information about a particular donor or to arrange the purchase of a sample.

### BRIEF DESCRIPTION OF THE SEVERAL VIEWS OF THE DRAWING

Drawing 1: Flow Chart Overview of Entire Service

Drawing 2: Flow Chart of Tissue Bank/Donor Segments

Drawing 3: Flow Chart of Participating Physician's Office Segment

Drawing 4: Flow Chart of Recipient/Patient Segment

FIG. 1A: Screenshot of Secure Portal

FIG. 2A: Screenshot of Tissue Bank Add Donor

FIG. 3A: Screenshot of Tissue Bank Manage Donors

FIG. 4A: Screenshot of Participating Physician's Office Register Patient

FIG. 5A: Screenshot of System Generated Username and Password

FIG. 6A: Screenshot of Patient Secure Portal

FIG. 7A: Screenshot of Patient Disclaimer

FIG. 9A: Screenshot of Search Results and Search Criteria

FIG. 10A: Screenshot of Link to Donor Page

### DETAILED DESCRIPTION OF THE INVENTION

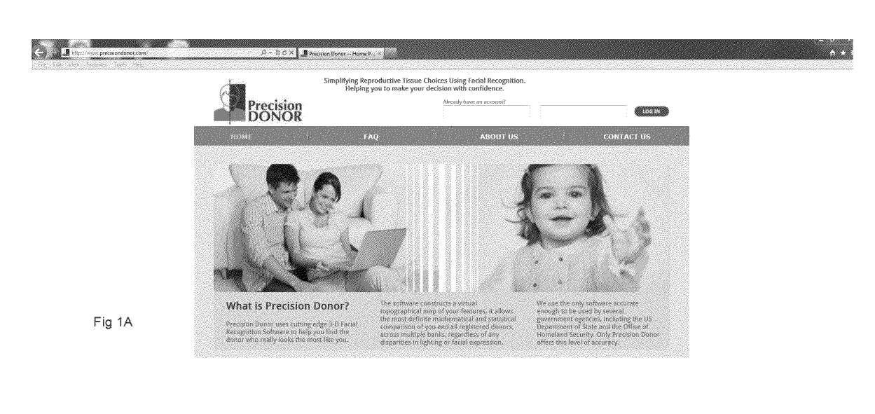

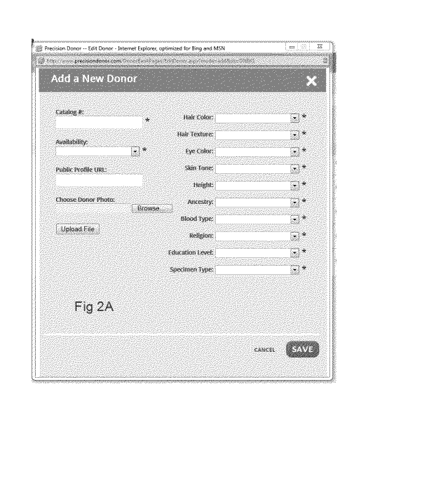

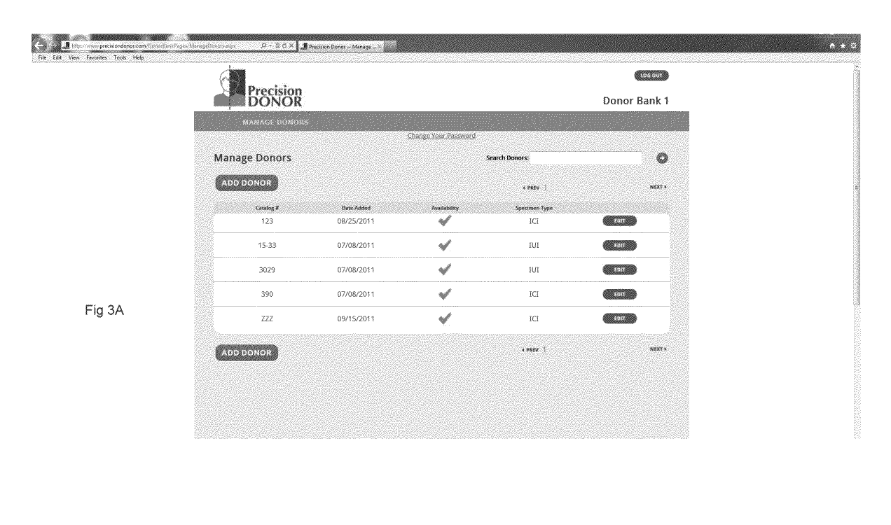

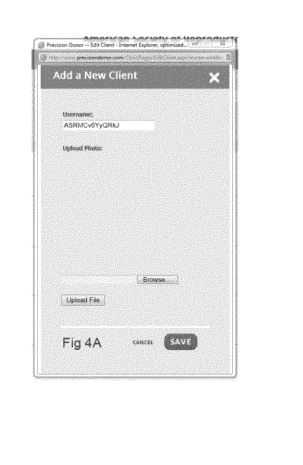

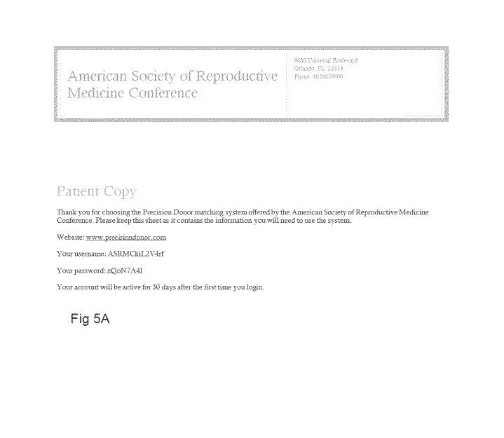

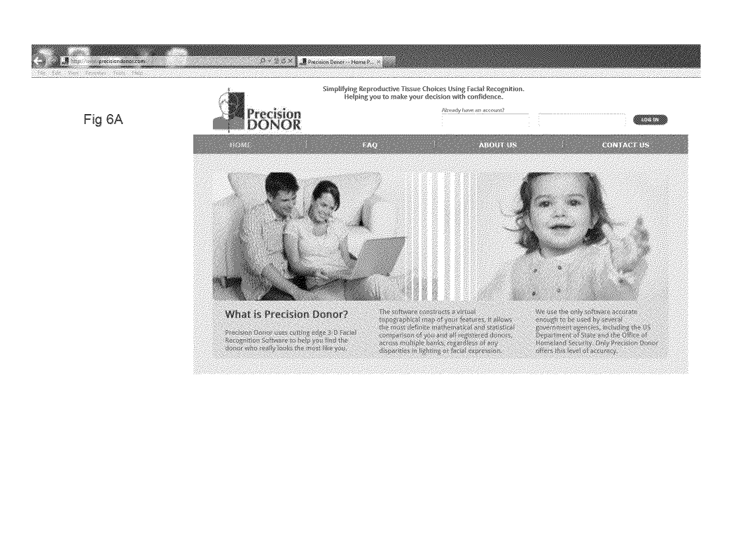

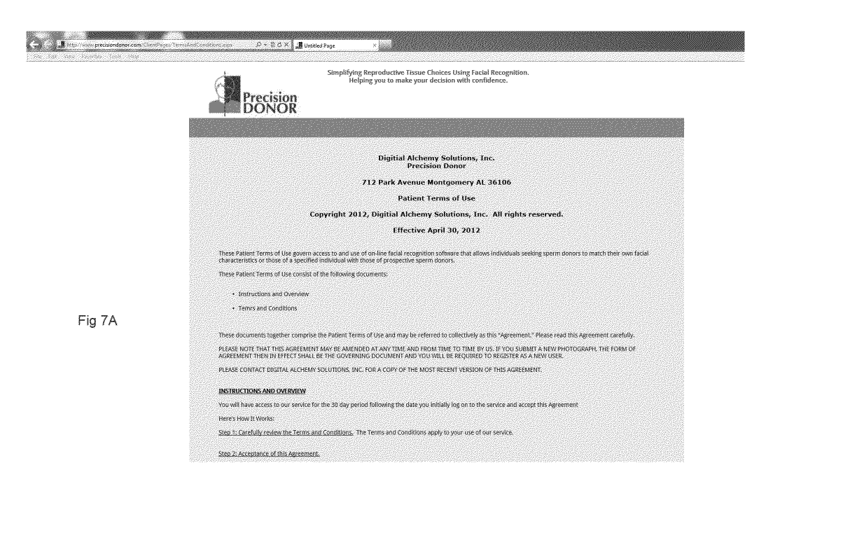

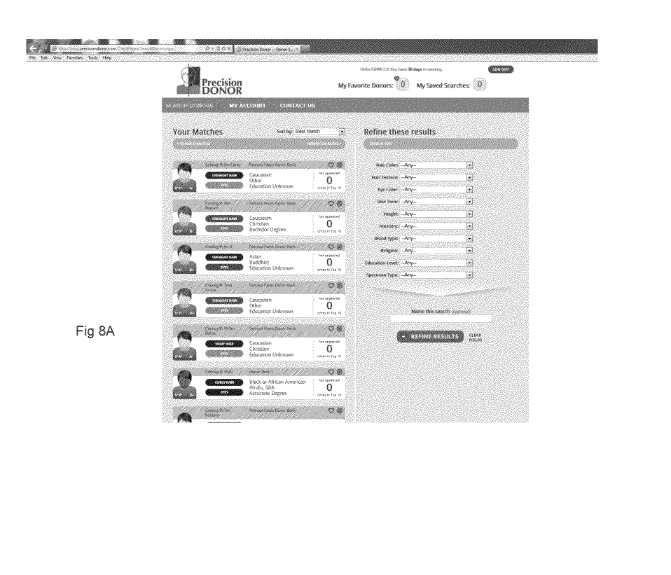

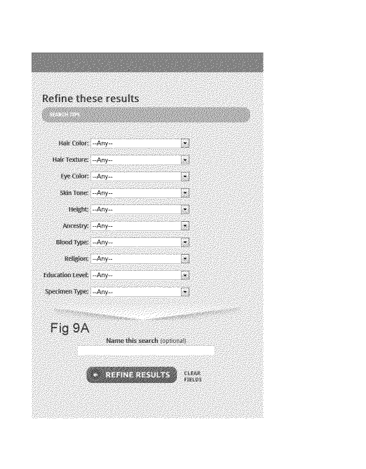

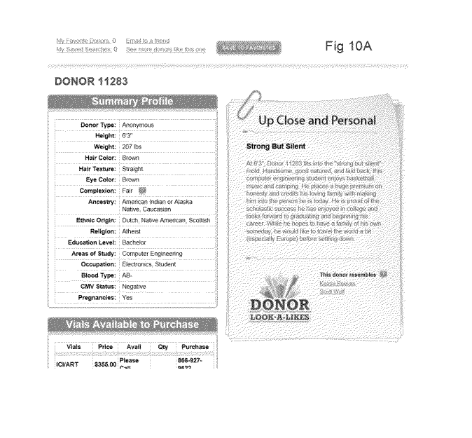

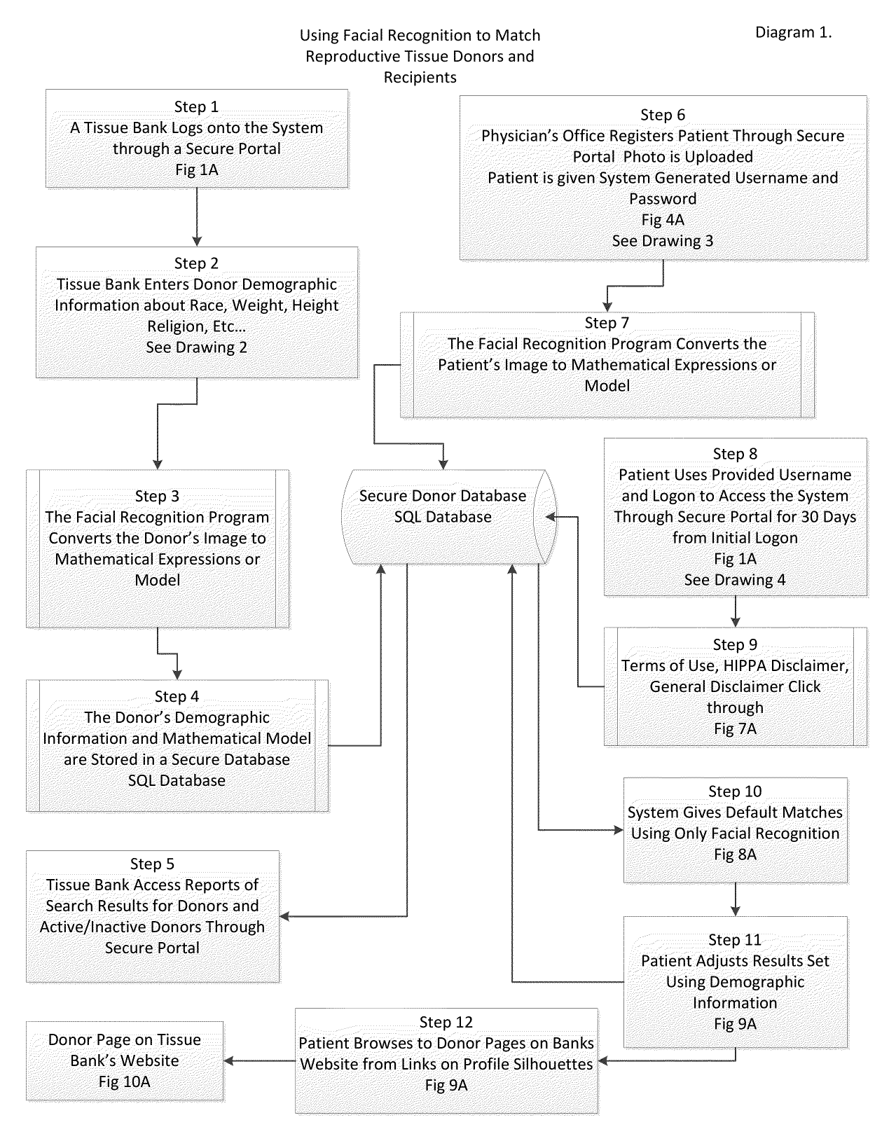

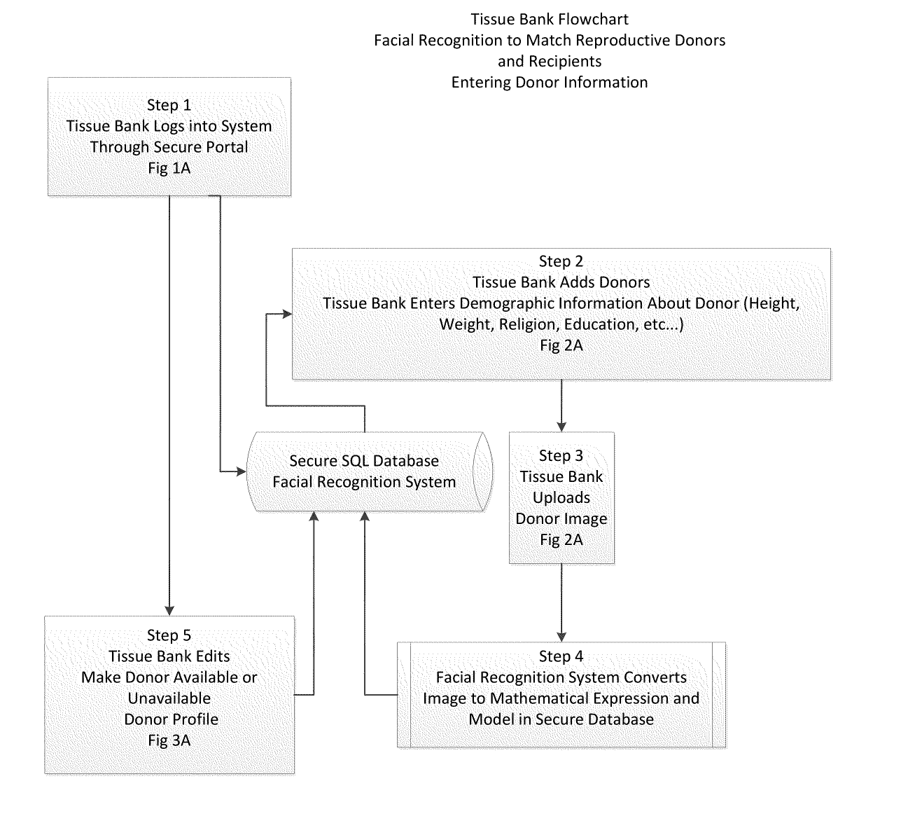

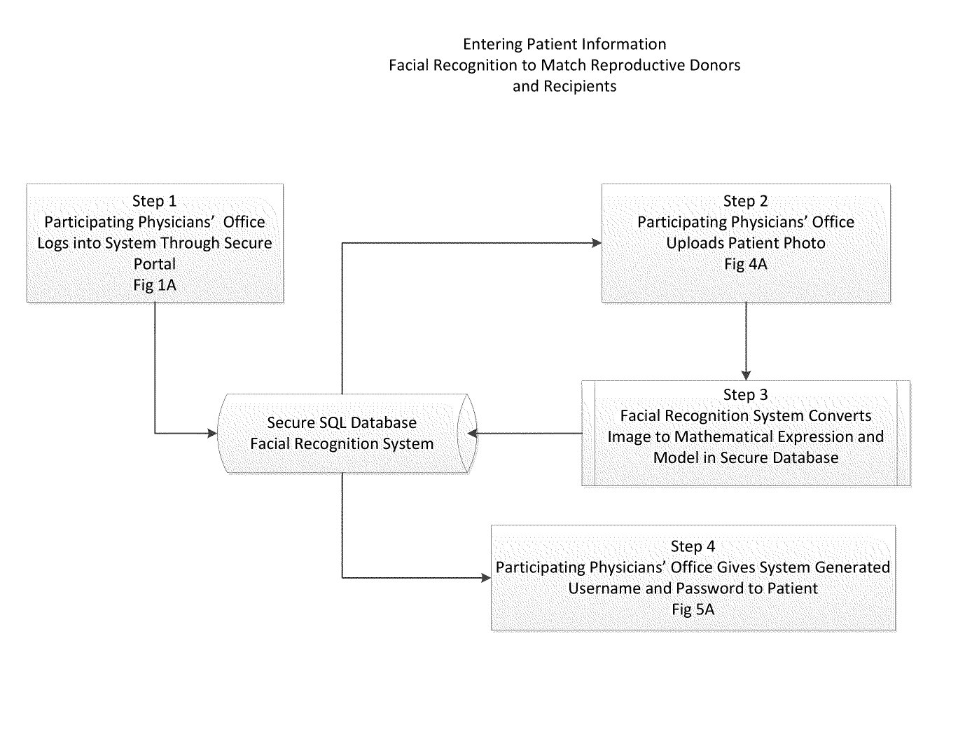

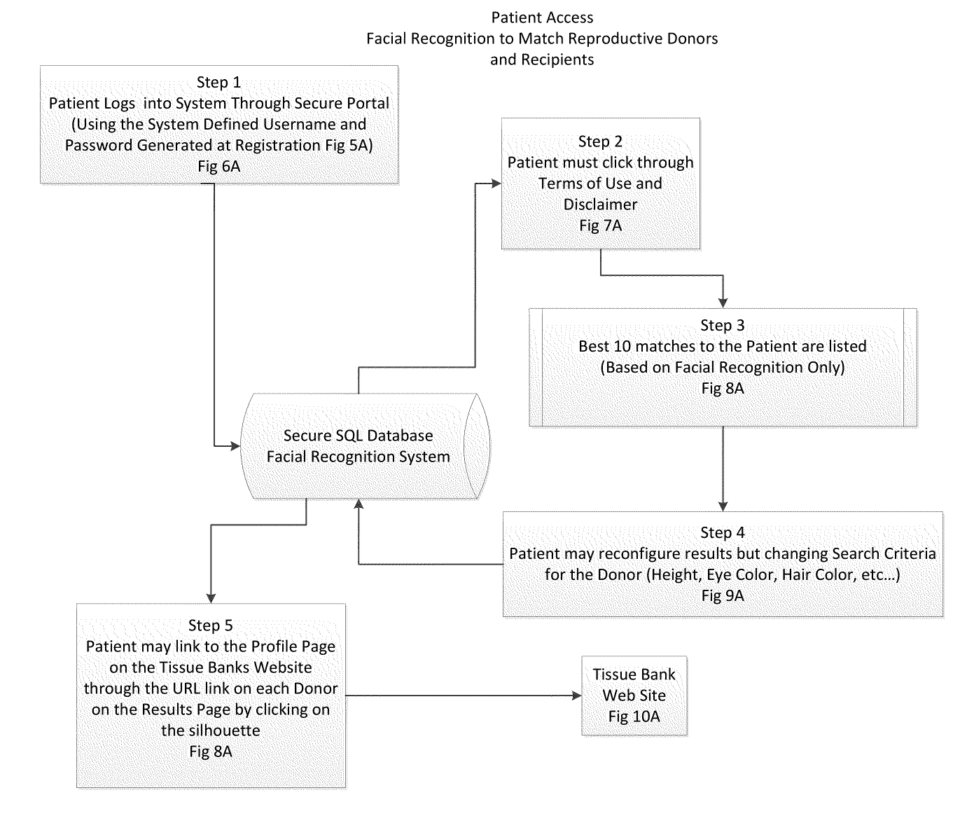

Participating Sperm Banks load their Sperm Donor images through our secure web portal (FIG. 1A). The images of the donors are run through a series of programs called Biometric Facial Recognition. These programs create mathematically precise models of the donors' facial features. They are stored by the system not as an image but as a series of mathematical expressions. A tissue bank enters the data on a donor, catalog number or donor number, availability, public profile URL, hair color, eye color, hair texture, skin tone, height, ancestry, blood type, religion, education level, specimen type, bank, and photo (the photo will be converted to an Eigen Mask by the FRP)(FIG. 2A). These profiles will be stored in a secure database. Tissue Banks can edit and manage donors through the management page (FIG. 3A). Participating Physician's Offices register patients through a secure web portal FIG. 1A). Patients enter their images through at Participating Physician's Office and the same process is applied (FIG. 4A). They are given a system generated username and password (FIG. 5A). When the Patient first logs in they are required to click through the Terms of Service and the Disclaimer (FIG. 7A). Patient's mathematical model is then compared to every model in the database and the 10 best matches are returned (FIG. 8A). The Patient may then include or exclude resultant donors based on adjustments made to the search criterion over the next 30 days from their initial login. Donors whose mathematic models most closely resemble the patient may possibly be excluded by the patient based on the inclusion/exclusion criteria selected (FIG. 9A). Once the list is narrowed down to a few donors the Patient may click on the link with any donor and be re-directed to the Participating Bank's Donor Page (FIG. 10A). They may then contact the Bank directly to obtain more information about a particular donor or to arrange the purchase of a sample.

Facial Recognition is software designed to match the image of one face with another. Simple systems measure only relative areas of light and darkness with relation to the subjects' eyes. Other systems measure only a set number of points (e.g. distance between eyes, eye to nose distance, etc . . . ). Both of these methods have a high rate of inaccuracy due to changes in light conditions and facial expressions

The first part of the software extracts the subjects face from the rest of the image. Every face has distinguishable landmarks. These are the peaks and valleys of the underlying bone and tissue structure that make up facial features. The software identifies these structures as nodal points and measures them. Every human face has approximately 80 nodal points. For Example: Distance Between the Eyes, Width of the Nose, Eye Socket Depth, Jawline Distance, Cheekbone Structure, etc . . . The nodal measurements are converted to mathematical expressions. These relational expressions do not change throughout a person's life, regardless of age or weight gain or loss. This is the most basic form of facial recognition but the accuracy of the results can be degraded by changes in facial expression and light.

The Second Process is Surface Texture Analysis. Surface Texture Analysis uses the uniqueness of an individual's skin to refine the selection process. Surface Texture Analysis works much the same way Facial Recognition does, only on a more refined level. Surface texture analysis takes the image of the skin and it is broken up into smaller units. These units are then converted to algorithms or mathematical expressions. The system distinguishes between lines, facial hair, pores and the actual skin texture. It can even identify and quantify the differences in identical twins.

The Third Process uses a Vector Template to confirm the subject and validate the facial recognition. The software identifies key features of the subject and extrapolates them to underlying bone and tissue structure. Using this method it can generate a 3-D “wire-model” of the subjects' complete face and verify the results of the first tow processes. Using all three methods assures that the match is accurate and precise.

1. Facial Recognition Programs (FRP) take precise measurements of the facial structure and construct what is called an Eigen Mask. An Eigen Mask is a series of mathematical expressions. The FRP compares the target (patient) Eigen Mask to all database Eigen Masks (donors). The privacy of both the patient and the donor is assured since the Eigen Mask and attached profile contain no identifying information, other than the system generated username and password. The patient can further refine the search by refining the criteria such as height, eye color, hair color, etc . . . Patients can link to the tissue banks public profile for donors they wish to research further.
